(19) United States
(12) Patent Application Publication
(10) Pub. No.: US 2006/0010737 A1
(43) Pub. Date: Jan. 19, 2006

(54) Combination memory disk and liquid ornament

(76) Inventor: Kuo-Vicent Lee, Taipei (TW)

Correspondence Address: BACON & THOMAS, PLLC, 625 SLATERS LANE, FOURTH FLOOR, ALEXANDRIA, VA, 22314, US

(21) Appl. No.: 11/000,014

(22) Filed: Dec. 1, 2004

(30) Foreign Application Priority Data
Jun. 11, 2004 (TW) 093204380

(51) Int. Cl. G09F 19/00

(52) U.S. Cl. 40/406

(57) ABSTRACT

The present invention discloses a combination memory disk and liquid ornament comprising a memory disk and a liquid ornament. The liquid ornament is coupled with the body of the memory disk. The liquid ornament has at least one liquid and a decorative structure.

### BACKGROUND OF THE INVENTION

1. Field of the Invention

The present invention relates to a combination memory disk and liquid ornament, and the memory disk such as a USB flash disk.

2. Description of the Related Art

Several patents have been granted regarding the combination of a liquid ornament with other objects to create a decorative effect; for example, in U.S. Pat. No. 6,380,926 several embodiments are disclosed, such as a cup having with a liquid ornament, or a toothbrush box with a liquid ornament.

However, no prior art discloses a combination memory disk and liquid ornament. Memory disks have been in use for over 10 years, and have become a necessary device for many people. Many design shapes for memory disks are developed each year, but none of the designs contain liquid ornaments.

Some users will hang their memory disks on their necks so that the memory disks look like a necklace. However, it is hard to make a memory disk become an attractive necklace.

### SUMMARY OF THE INVENTION

A main objective of the present invention is to provide a combination memory disk and liquid ornament, which causes the memory disk seen more enjoyable and interesting. The present invention can also be easily used as an attractive necklace

Another objective of the present invention is to provide a combination memory disk and liquid ornament acts as a promotion good for an advertisement purpose.

In order to achieve the above mentioned objectives, the present invention, a combination memory disk and liquid ornament comprises an memory disk and a liquid ornament. The liquid ornament is coupled with the body of the memory disk. The liquid ornament has at least one liquid and a decorative structure. The decorative structure can be any attractive object such as a cute animal, or a logo such as a beer bottle or a trademark so that the present invention can achieve advertisement purpose.

According to some of embodiments, the size of the liquid ornament can be larger to increase ornamental effect. In addition, the liquid ornament can act as the container for the memory disk.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment according to the present invention.

FIG. 2 is a side view of a first embodiment according to the present invention.

FIG. 3 is a perspective view of a second embodiment according to the present invention.

FIG. 4 is a side view of a second embodiment according to the present invention.

FIG. 5 is a perspective view of a third embodiment according to the present invention.

FIG. 6 is a perspective view of a forth embodiment according to the present invention.

FIG. 7 is a perspective view of a forth embodiment according to the present invention, showing the memory disk on the overturned position.

FIG. 8 is a perspective view of a fifth embodiment according to the present invention.

FIG. 9 is a perspective view of a fifth embodiment according to the present invention, showing the memory disk being pulled out.

### DETAILED DESCRIPTION OF THE PREFERRED EMBODIMENT

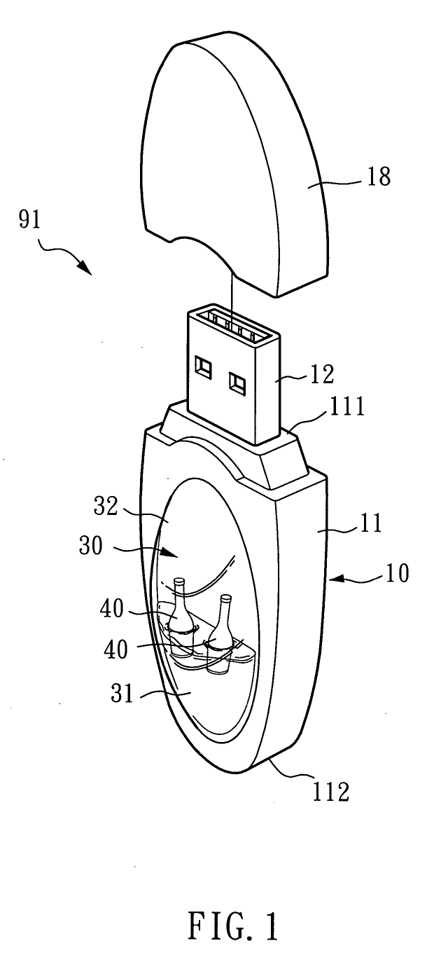

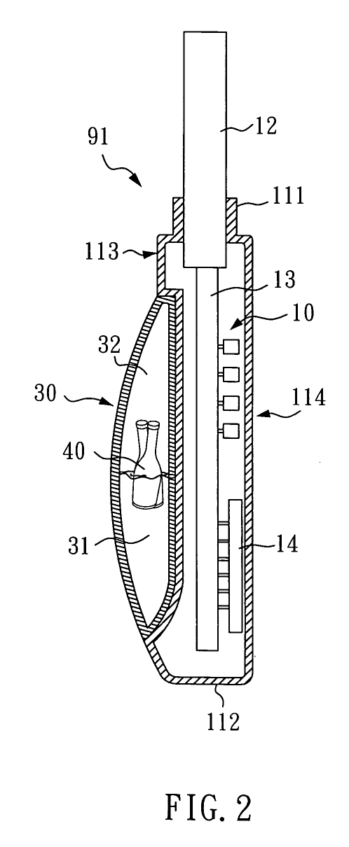

Please refer to FIG. 1 and FIG. 2 for a first embodiment. A combination memory disk and liquid ornament 91 comprises two major components, a memory disk 10 and a liquid ornament 30.

The memory disk 10 comprising a body 11, a plug 12 and a circuit mechanism 13. The body 11 has a front end 111, a rear end 112 and two sides 113, 114. The circuit mechanism 13 has a memory 14 and control circuits/IC (not shown). The plug 12 is mounted on the front end 111 of the body 11 and is electrically connected with the circuit mechanism 13. The memory disk 10 shown on the FIG. 1 and FIG. 2 is a USB flash disk which is the most popular memory disk these two years. A cap 18, which is a component for many types of USB flash disks, is used to protect the plug 12 when the memory disk 10 is not used. Because the memory disk 10 (e.g. USB flash disk) is a well-known apparatus, the details of the memory disk 10 is not within the field of the subject matter of the present invention, and so details of such a mechanism for the memory disk 10 are not explained hereafter.

The liquid ornament 30 is coupled with the body 11 of the memory disk 10. In the first embodiment, the liquid ornament 30 is coupled with the side 113 of the body 11. The liquid ornament 30 comprises at least one liquid and a decorative structure 40. According to the embodiment, there are two liquids, a first liquid 31 and a second liquid 32. The second liquid 32 is less dense than the first liquid 31, and they usually have different colors. The decorative structure 40 is insoluble and floats between the first liquid 31 and the second liquid 32.

There are many ways to fix the liquid ornament 30 on the body 11. However, since combining two objects are well known, the detailed description for doing so is omitted. For the first embodiment, the liquid ornament 30 is embedded in the body 11 so that the liquid ornament 30 looks like a integral portion of the body 11.

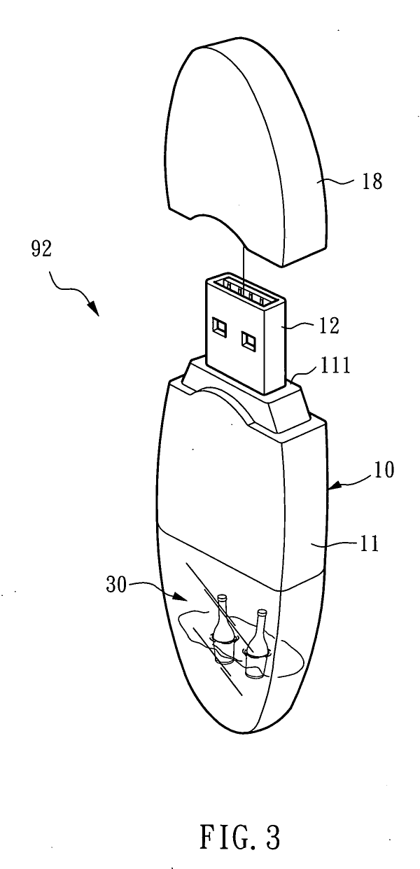

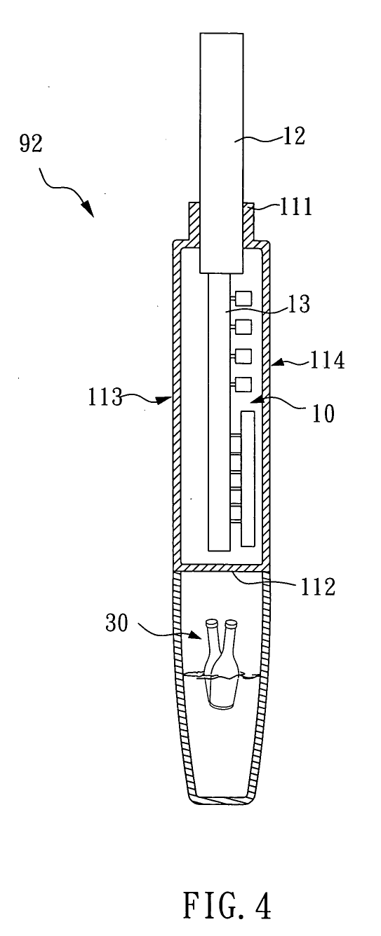

Please refer to FIG. 3 and FIG. 4 for a second embodiment, a combination memory disk and liquid ornament 92. In comparison with the aforesaid first embodiment, the major difference is that the liquid ornament 30 is coupled with the rear end 112 of the body 11 so that the liquid ornament 30 can be made thicker.

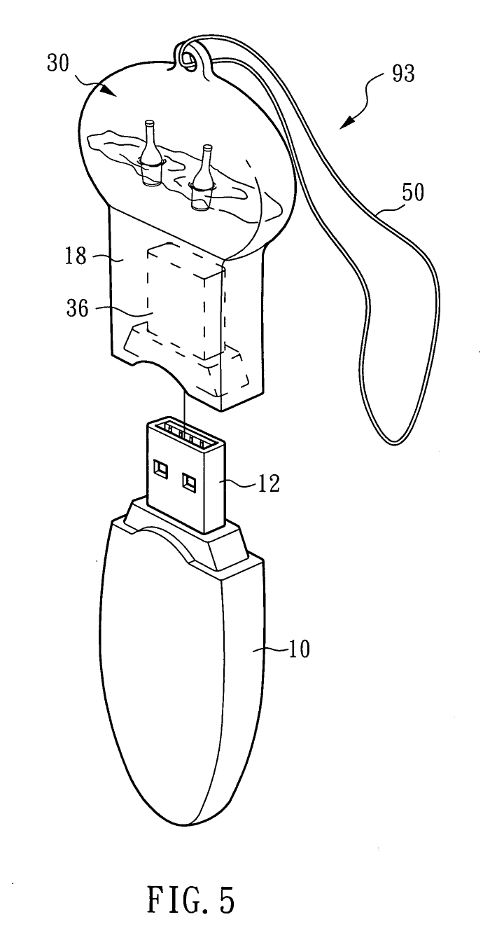

Please refer to FIG. 5 for a third embodiment, a combination memory disk and liquid ornament 93. The liquid ornament 30 has a recess 36 so that the plug 12 can be inserted therein. Therefore, the liquid ornament 30 can act as a cap 18 of the memory disk 10. A string 50 can be connected with the liquid ornament 30 on an appropriate position so that a user can wear the string 50 on his/her neck. Therefore, the combination memory disk and liquid ornament 93 is like a necklace and the liquid ornament 30 becomes a necklace ornament.

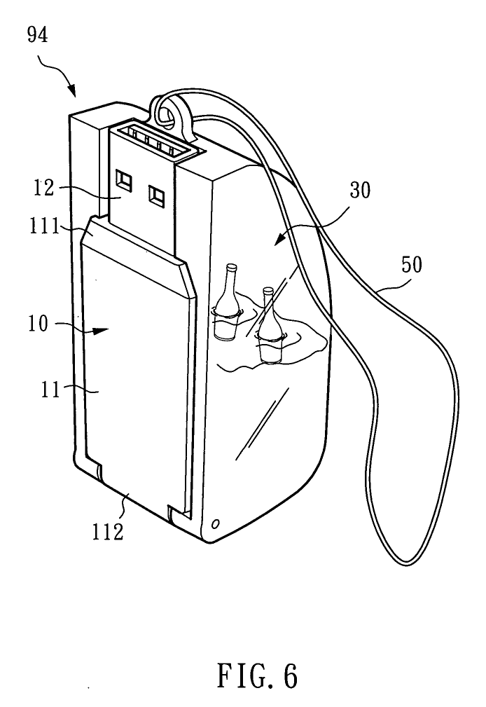

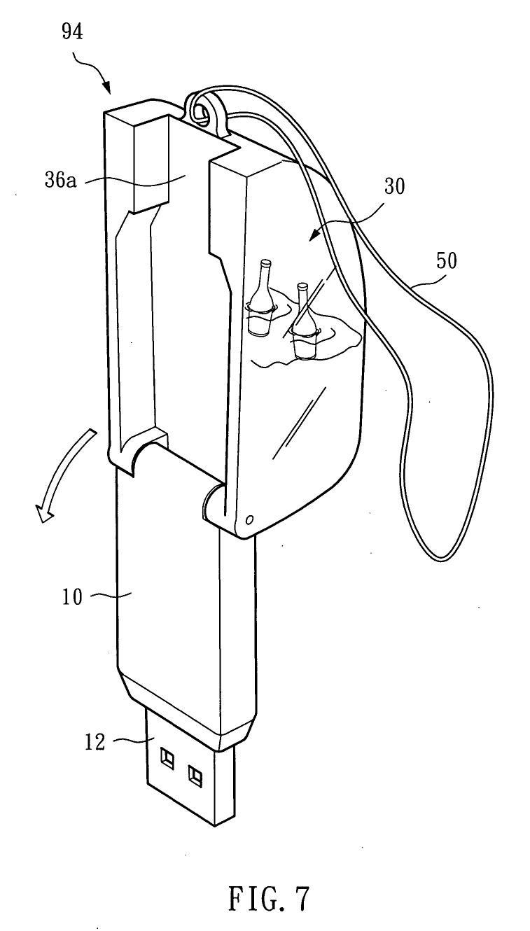

Please refer to FIG. 6 and FIG. 7 for a forth embodiment, a combination memory disk and liquid ornament 94. The liquid ornament 30 is pivotly coupled with the rear end 112 of the body 11. Since the pivot mechanism is well known, the detailed description for doing so is omitted. The liquid ornament 30 preferably has a recess 36a so that the memory disk 10 can be embedded in the recess 36a. When the user needs to use the memory disk 10, the user can overturn the memory disk 10 as shown on FIG. 7. Similarly, the string 50 can be applied in forth embodiment so that the combination memory disk and liquid ornament 94 can act as a necklace.

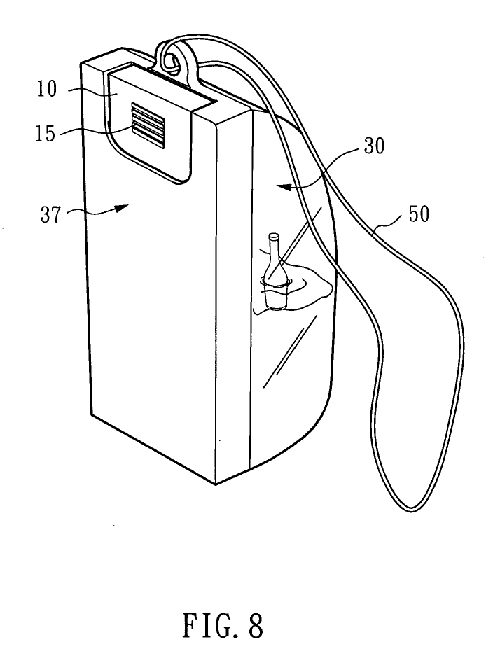

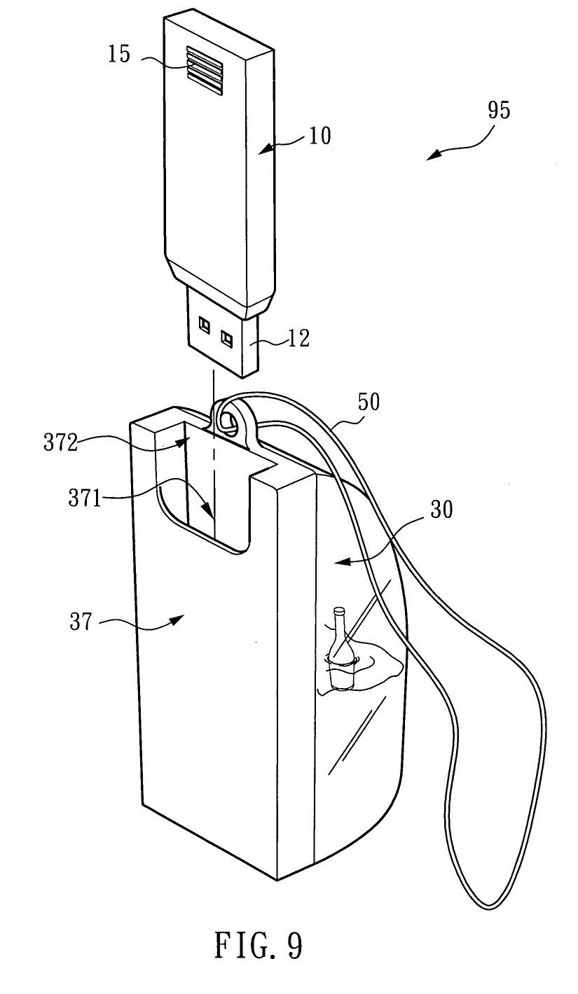

Please refer to FIG. 8 and FIG. 9 for a fifth embodiment, a combination memory disk and liquid ornament 95. The liquid ornament 30 further comprises a shell 37 with a containing space 371 (the shell 37 can be an independent part attached to the liquid ornament 30, or the shell 37 is an integral part of the liquid ornament 30). When the memory disk 10 is unused, it can be put in the containing space 371. When the user intends to use, the user just pull the memory disk 10 out. In a preferred design, the shell 37 has an indentation 372 and the memory disk 10 has anti-slipping element 15 on the corresponding position of the indentation 372. Then the user can use his finger to pull out the memory disk 10 very easily.

The common purpose of the third, forth and fifth embodiments is to increase the size of the liquid ornament 30. In the forth and fifth embodiments, the liquid ornament 30 can even contain the memory disk 10.

Although the present invention has been explained in relation to its preferred embodiment, it is to be understood that many other possible modifications and variations can be made without departing from the spirit and scope of the invention as hereinafter claimed. Fro example, many memory disk is integrated with other function such as MP3 player function, audio recoding function etc. This type of multi-function electrical device is also a type of memory disk defined in the present invention.

What is claimed is:

1. A combination memory disk and liquid ornament comprises:
a memory disk comprising a plug, a body having a front end, a rear end and two sides, and a circuit mechanism disposed in the body, wherein the circuit mechanism has a memory, and the plug is mounted on the front end of the body and is connected with the circuit mechanism; and
a liquid ornament comprising at least one liquid and at least one decorative structure being insoluble in the liquid, wherein the liquid ornament is coupled with the body of the memory disk.

2. The combination memory disk and liquid ornament as claimed in claim 1, wherein the liquid ornament is coupled with one side of the body.

3. The combination memory disk and liquid ornament as claimed in claim 1, wherein the liquid ornament is coupled with the rear end of the body.

4. The combination memory disk and liquid ornament as claimed in claim 1, wherein the liquid ornament is coupled with the front end of the body and acts as a cap of the memory disk.

5. The combination memory disk and liquid ornament as claimed in claim 1, wherein the manner of the liquid ornament coupled with the body is pivoting manner.

6. The combination memory disk and liquid ornament as claimed in claim 1, wherein the liquid ornament further comprising a shell with a containing space, so that the memory disk can be put in the containing space.

7. The combination memory disk and liquid ornament as claimed in claim 1 further comprising a string.
